(19) United States
(12) Patent Application Publication
(10) Pub. No.: US 2026/0264433 A1
(43) Pub. Date: Sep. 10, 2026

(54) LIQUID EJECTION DEVICE

(71) Applicant: SEIKO EPSON CORPORATION, Tokyo (JP)

(72) Inventors: Hiroyuki NAKAMURA, SHIOJIRI-SHI (JP); Fumiya TAKINO, SHIOJIRI-SHI (JP); Soshi OKAWA, SHIOJIRI-SHI (JP)

(21) Appl. No.: 19/554,027

(22) Filed: Mar. 2, 2026

(30) Foreign Application Priority Data
Mar. 5, 2025 (JP) 2025-034386

(51) Int. Cl. B41J 29/393; B41J 2/155; B41J 2/175

(52) U.S. Cl. CPC B41J 29/393; B41J 2/155; B41J 2/17596

(57) ABSTRACT

The liquid ejection device includes a head unit including a liquid ejection head that ejects liquid in an ejection direction and a plurality of wiring sections that are attachable to and detachable from the head unit and that supply electric signals to the liquid ejection head. The head unit includes a flow path joint can be coupled to a downstream end of a supply flow path for supplying liquid to the liquid ejection head. The liquid ejection head is a line head extending in a longitudinal direction intersecting with an ejection direction. When viewed from the ejection direction, the plurality of wiring sections does not overlap the supply flow path coupled to the flow path joint at a position overlapping the liquid ejection head in a case where the head unit is mounted on the head unit.

### CROSS REFERENCE TO RELATED APPLICATION

The present application is based on, and claims priority from JP Application Serial Number 2025-034386, filed Mar. 5, 2025, the disclosure of which is hereby incorporated by reference herein in its entirety.

### BACKGROUND

### 1. Technical Field

The present disclosure relates to a liquid ejection device.

### 2. Related Art

For example, as in JP-A-2016-175279, a liquid ejection device including a liquid ejection head that ejects liquid onto a medium and a plurality of tubes for supplying the liquid to the liquid ejection head is disclosed. The plurality of tubes is coupled to a supply section that supplies the liquid to the liquid ejection head. The liquid ejection head is supplied with an electric signal via a plurality of flexible flat cables, which are an example of a wiring section. The plurality of wiring sections is arranged above the liquid ejection head and below the plurality of tubes.

However, in such a liquid ejection device, it is desired to improve the workability of detaching the plurality of wiring sections when performing maintenance of the liquid ejection head.

### SUMMARY

A liquid ejection device that solves the above-described problem includes a head unit including a liquid ejection head that ejects liquid in an ejection direction and a plurality of wiring sections that are attachable to and detachable from the head unit and that supply electric signals to the liquid ejection head, wherein the head unit includes a flow path joint configured to couple to a downstream end of a supply flow path for supplying liquid to the liquid ejection head, the liquid ejection head is a line head extending in a longitudinal direction that intersects the ejection direction, and when viewed from the ejection direction while the plurality of wiring sections are mounted to the head unit, the wiring sections do not overlap with the supply flow path coupled to the flow path joint at a position where the wiring sections overlap with the liquid ejection head.

### BRIEF DESCRIPTION OF THE DRAWINGS

FIG. 1 is a schematic diagram illustrating a liquid ejection device according to first embodiment.

FIG. 2 is a plan view illustrating the head unit according to the first embodiment.

FIG. 3 is a plan view illustrating the head unit according to the first embodiment.

FIG. 4 is a plan view illustrating the head unit according to the first embodiment.

FIG. 5 is a rear view illustrating the head unit according to the first embodiment.

FIG. 6 is a schematic view illustrating a negative pressure release section of the first embodiment.

FIG. 7 is a flowchart illustrating a cleaning control process according to the first embodiment.

FIG. 8 is a schematic view illustrating a negative pressure release section of a second embodiment.

### DESCRIPTION OF EMBODIMENTS

### FIRST EMBODIMENT

Hereinafter, an embodiment of a liquid ejection device will be described. In the following description, a direction intersecting the vertical direction Z is referred to as a width direction X, and a direction intersecting the vertical direction Z and the width direction X is referred to as a front-rear direction Y. The vertical direction Z corresponds to an example of a first direction. One direction along the width direction X is referred to as a first width direction X1, and the other direction along the width direction X is referred to as a second width direction X2. One direction along the front-rear direction Y is referred to as the forward direction Y1, and the other direction along the front-rear direction Y is referred to as the backward direction Y2. An upward side in the vertical direction Z is referred to as an upward direction Z1, and a downward side in the vertical direction Z is referred to as a downward direction Z2. A plan view from the upward direction Z1 is simply referred to as a plan view.

### Configuration of liquid ejection device 11

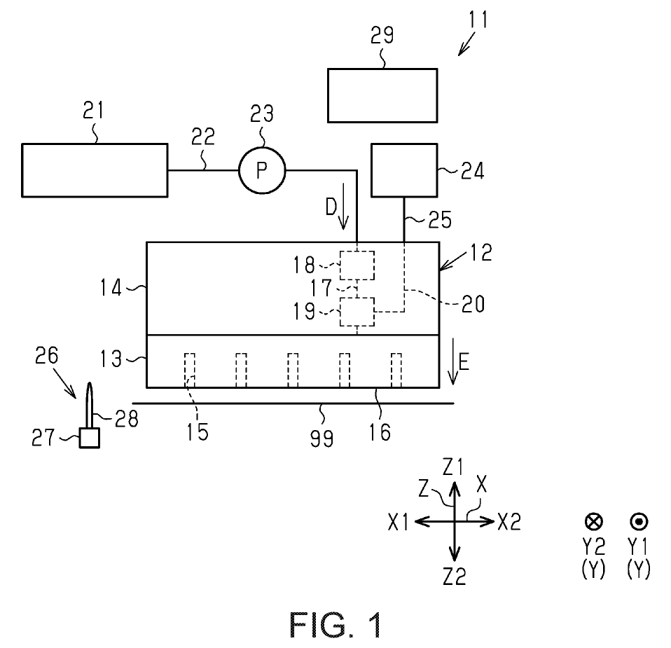

As illustrated in FIG. 1, a liquid ejection device 11 performs printing on a medium 99 by ejecting liquid onto the medium 99. The liquid ejection device 11 may be an inkjet printer that ejects ink, which is an example of a liquid, onto the medium 99.

The liquid ejection device 11 includes a head unit 12. The head unit 12 is a unit for ejecting liquid. The head unit 12 includes a liquid ejection head 13 and a supply section 14. That is, the liquid ejection device 11 includes the liquid ejection head 13 and the supply section 14.

The liquid ejection head 13 is configured to eject liquid. The liquid ejection head 13 is capable of ejecting liquid onto the medium 99 transported by a transport section (not illustrated). The liquid ejection head 13 includes at least one nozzle 15 and a nozzle surface 16. The nozzles 15 are open to the nozzle surface 16. The liquid ejection head 13 ejects liquid from the nozzles 15. The nozzle surface 16 is a surface facing the medium 99. The nozzle surface 16 is a surface facing an ejection direction E. The ejection direction E is a direction in which the liquid ejection head 13 ejects liquid. The ejection direction E is a downward direction Z2, but may be inclined with respect to the vertical direction Z. In this manner, the liquid ejection head 13 is configured to eject the liquid in the ejection direction E.

The liquid ejection head 13 is a line head but may be a serial head. The line head is a head extending in the width direction of the medium 99. The width direction of the medium 99 corresponds to the longitudinal direction of the liquid ejection head 13. The width direction of the medium 99 may be the width direction X. The width direction of the medium 99 is a direction intersecting the ejection direction E. The line head is a head that ejects liquid all at once across the width direction of the medium 99. The serial head is configured to scan in a width direction of the medium 99 and to eject liquid.

The supply section 14 is configured to supply liquid to the liquid ejection head 13. The supply section 14 may be provided on the upward direction Z1 of the liquid ejection head 13. The supply section 14 may be attachable to and detachable from the liquid ejection head 13.

The supply section 14 includes a liquid supply flow path 17, a liquid pressure regulating valve 18, and a negative pressure release section 19. The liquid supply flow path 17 is a flow path for supplying liquid from a liquid storage section 21 (to be described later) to the liquid ejection head 13.

The liquid pressure regulating valve 18 is provided upstream of the negative pressure release section 19 in the supply direction D. The supply direction D is a direction in which the liquid is supplied from a liquid storage section 21 (to be described later) to the liquid ejection head 13. The liquid pressure regulating valve 18 regulates the pressure of the liquid supplied to the liquid ejection head 13 to a regulated pressure at which the liquid can be ejected from the nozzles 15. The liquid pressure regulating valve 18 is a valve mechanism for maintaining the negative pressure of the nozzles 15. The liquid pressure regulating valve 18 is a differential pressure valve. The liquid pressure regulating valve 18 is also called a pressure reducing valve or a self-sealing valve.

The negative pressure release section 19 is provided upstream of the liquid ejection head 13 in the supply direction D. The negative pressure release section 19 is provided downstream of the liquid pressure regulating valve 18 in the supply direction D. The negative pressure release section 19 may be provided to release the negative pressure of the nozzles 15 and eject a predetermined amount of liquid from the liquid ejection head 13 when cleaning the liquid ejection head 13.

The supply section 14 includes a gas supply flow path 20. The gas supply flow path 20 is a flow path through which gas is supplied. The gas is supplied from the gas supply flow path 20 to the negative pressure release section 19, and thus the liquid is supplied from the negative pressure release section 19 to the liquid ejection head 13. That is, the gas supply flow path 20 is an example of a flow path for supplying liquid to the liquid ejection head 13.

The liquid ejection device 11 may include a liquid storage section 21, a first supply flow path 22, and a feed pump 23. The liquid storage section 21 can store the liquid to be supplied to the liquid ejection head 13. The liquid storage section 21 may be an ink tank attached to the liquid ejection device 11 or may be an ink cartridge that is attachable to and detachable from the liquid ejection device 11.

The upstream end of the first supply flow path 22 in the supply direction D is coupled to the liquid storage section 21. The first supply flow path 22 causes the liquid to flow out from the liquid storage section 21. The downstream end of the first supply flow path 22 in the supply direction D is coupled to the head unit 12.

Specifically, the downstream end of the first supply flow path 22 in the supply direction D is coupled to the supply section 14. The downstream end of the first supply flow path 22 in the supply direction D is coupled to the liquid supply flow path 17. The first supply flow path 22 supplies the liquid stored in the liquid storage section 21 to the liquid ejection head 13. That is, the first supply flow path 22 is an example of a supply flow path for supplying the liquid to the liquid ejection head 13.

The feed pump 23 is provided in the first supply flow path 22. The feed pump 23 supplies the liquid from the liquid storage section 21 to the liquid ejection head 13. The feed pump 23 may be, for example, any one of a diaphragm pump, a tube pump, a gear pump, and a piston pump.

The liquid ejection device 11 includes an air pressure regulating section 24 and a second supply flow path 25. The air pressure regulating section 24 is configured to adjust the air pressure in the negative pressure release section 19. The air pressure regulating section 24 can pressurize the negative pressure release section 19.

The upstream end of the second supply flow path 25 is coupled to the air pressure regulating section 24. The second supply flow path 25 allows the gas from the air pressure regulating section 24 to flow out. The downstream end of the second supply flow path 25 is coupled to the head unit 12.

Specifically, the downstream end of the second supply flow path 25 is coupled to the supply section 14. The downstream end of the second supply flow path 25 is coupled to the upstream end of the gas supply flow path 20. The second supply flow path 25 supplies the gas from the air pressure regulating section 24 to the negative pressure release section 19. In this manner, the second supply flow path 25 is a flow path that supplies gas for supplying liquid to the liquid ejection head 13. That is, the second supply flow path 25 is an example of a supply flow path for supplying liquid to the liquid ejection head 13.

The liquid ejection device 11 includes a wiping section 26. The wiping section 26 is configured to wipe the nozzle surface 16. The wiping section 26 may be configured to wipe the nozzle surface 16 after the liquid is ejected in cleaning the liquid ejection head 13.

The wiping section 26 includes a main body section 27 and a wiping member 28. The wiping member 28 is arranged in the main body section 27 so as to face the direction opposite to the ejecting direction E. The main body section 27 may be movable in the width direction X. The wiping member 28 wipes the nozzle surface 16 by the main body section 27 moving in the width direction X in a state of being in contact with the nozzle surface 16.

The liquid ejection device 11 includes a control section 29. The control section 29 controls the liquid ejection device 11. In particular, the control section 29 controls the head unit 12. Specifically, the control section 29 controls the liquid ejection head 13. The control section 29 controls the feed pump 23. The control section 29 controls the air pressure regulating section 24.

The control section 29 may be constituted by one or more processors that execute various processes in accordance with a computer program. The control section 29 may be composed of one or more dedicated hardware circuits. The control section 29 may be configured with an application specific integrated circuit that executes at least a part of various processes. The control section 29 may be composed of a processor and a circuit including a combination of hardware circuits. The processor includes a CPU and memory, such as RAM and ROM. The memory stores program codes or commands configured to cause the CPU to perform processes. Memory, that is, computer-readable medium, includes any readable medium that can be accessed by a general-purpose or dedicated computer.

### Configuration of head unit 12

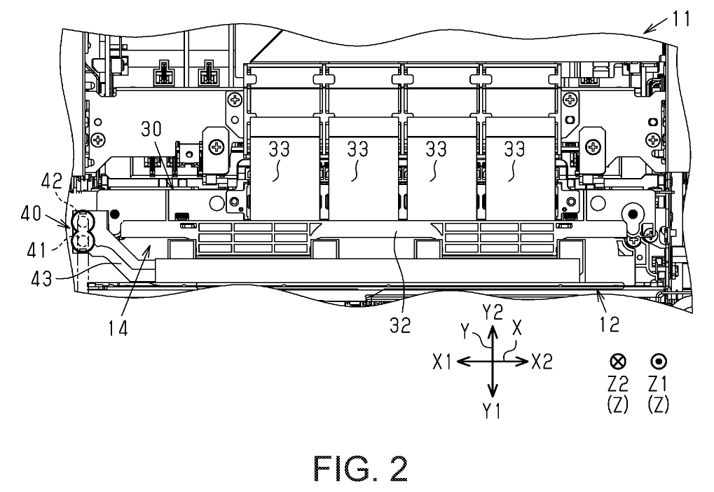

As illustrated in FIG. 2, the liquid ejection device 11 includes a relay board unit 30. The relay board unit 30 is configured such that the width direction X is longer than the front-rear direction Y. The relay board unit 30 is configured to extend in the longitudinal direction of the liquid ejection head 13.

The relay board unit 30 is attachable to and detachable from the head unit 12. The relay board unit 30 is attachable to and detachable from the head unit 12 in a state where a plurality of wiring sections 33 (to be described later) are coupled to the relay board unit 30. The relay board unit 30 can be mounted on the backward direction Y2 side with respect to the liquid ejection head 13. The supply section 14 is provided on the forward direction Y1 side with respect to the liquid ejection head 13.

The relay board unit 30 is a unit for supplying an electric signal from the control section 29 to the liquid ejection head 13. The relay board unit 30 may be a unit for supplying an electric signal from the liquid ejection head 13 to the control section 29.

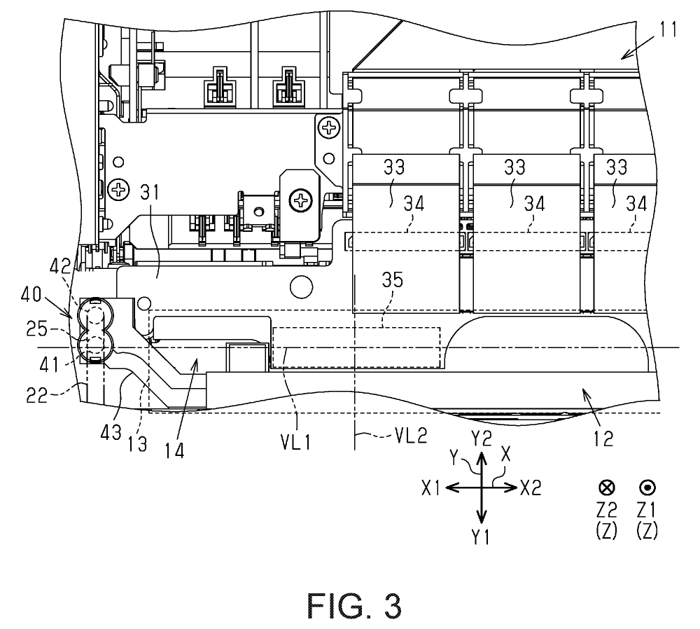

The relay board unit 30 includes a relay board 31 illustrated in FIG. 3 (to be described later) and a relay board case 32. That is, the liquid ejection device 11 includes the relay board 31 and the relay board case 32.

The relay board case 32 is a member that accommodates the relay board 31. The relay board case 32 may be a resin member. The relay board case 32 may cover the relay board 31 from at least the upward direction Z1 side. Therefore, the relay board 31 can be handled to be attachable to and detachable from the head unit 12 in a state of being covered with the relay board case 32 and in a state of being mounted with the plurality of wiring sections 33 (to be described later).

That is, the relay board unit 30 can be collectively handled in a state where the plurality of wiring sections 33 (to be described later) are mounted. In particular, the relay board unit 30 can be collectively and temporarily placed in a state where the plurality of wiring sections 33 (to be described later) are mounted thereon.

The liquid ejection device 11 includes the plurality of wiring sections 33. The plurality of wiring sections 33 may be provided on the second width direction X2 side with respect to the center of the relay board unit 30 in the widthwise direction X. The plurality of wiring sections 33 are members for supplying an electric signal from the control section 29 to the liquid ejection head 13. The plurality of wiring sections 33 may be members for supplying an electric signal from the liquid ejection head 13 to the control section 29. The plurality of wiring sections 33 may be flexible flat cables.

The plurality of wiring sections 33 may be attachable to and detachable from the relay board unit 30. The plurality of wiring sections 33 may be attachable to and detachable from the head unit 12 via the relay board unit 30. That is, the plurality of wiring sections 33 may be attachable to and detachable from the head unit 12.

As illustrated in FIG. 3, the relay board 31 is configured such that the width direction X is longer than the front-rear direction Y. The relay board 31 is configured to extend in the longitudinal direction of the liquid ejection head 13. The relay board 31 is provided on the backward Y2 side of the supply section 14.

The relay board 31 is attachable to and detachable from the head unit 12. The relay board 31 can be mounted on the backward Y2 side with respect to the liquid ejection head 13. In plan view, the relay board 31 can be mounted on the liquid ejection head 13 on the backward direction Y2 side opposite to the region where the supply section 14 is provided in plan view.

The relay board 31 is a substrate for supplying an electric signal from the control section 29 to the liquid ejection head 13. The relay board 31 may be a circuit board for supplying an electric signal from the liquid ejection head 13 to the control section 29.

The relay board unit 30 includes a wiring connector 34. The relay board unit 30 may include a plurality of wiring connectors 34. The wiring connector 34 is provided on the top face of the relay board 31. The wiring connector 34 is provided on the backward Y2 side of the relay board 31. The plurality of wiring connectors 34 may be provided on the second width direction X2 side with respect to the center of the relay board 31 in the width direction X. The plurality of wiring sections 33 can be coupled to the plurality of wiring connectors 34, respectively. In this way, the plurality of wiring sections 33 are attachable to and detachable from the relay board 31 via the plurality of wiring connectors 34. The wiring connector 34 is a connector for driving the liquid ejection head 13.

The relay board unit 30 includes a relay board connector 35. The relay board unit 30 may include a plurality of relay board connectors 35. The relay board connector 35 is provided on the bottom surface of the relay board 31. The relay board connector 35 is provided on the forward direction Y1 side of the relay board 31. The relay board connector 35 can be coupled to a head board connector 37 of a head board 36. That is, the relay board 31 is attachable to and detachable from the head unit 12 via the relay board connector 35 and the head board connector 37. The plurality of relay board connectors 35 may be provided so as to be arranged in the width direction X. The relay board connector 35 is a connector for driving the liquid ejection head 13.

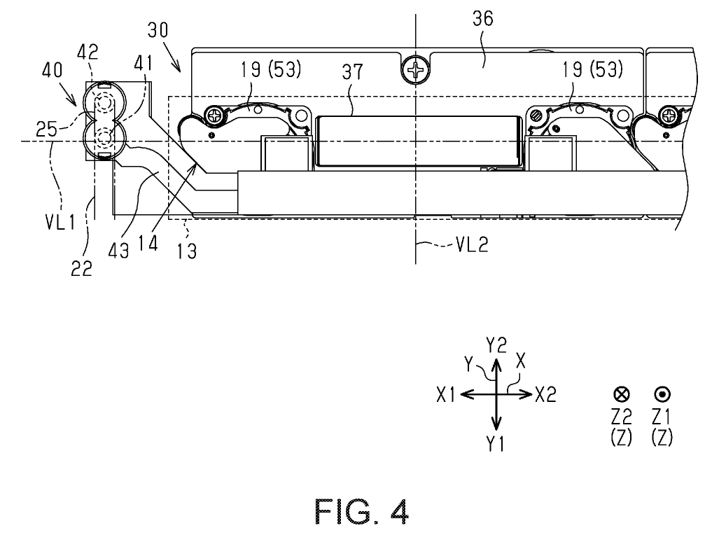

As illustrated in FIG. 4, the head unit 12 includes the head board 36. The head board 36 is provided on a upward direction Z1 above the liquid ejection head 13. The head board 36 is configured such that the width direction X is longer than the front-rear direction Y. The head board 36 is configured to extend in the longitudinal direction of the liquid ejection head 13. The head board 36 is a circuit board for controlling the liquid ejection head 13.

The head unit 12 includes the head board connector 37. The head unit 12 may include a plurality of head board connectors 37. The head board connector 37 is provided on the top face of the head board 36.

The head board connector 37 can be coupled to the relay board connector 35. The head board connector 37 is a connector for driving the liquid ejection head 13. The head board connector 37 transmits an electric signal from the control section 29 to the head board 36 via the relay board connector 35.

The supply section 14 includes a flow path joint 40. That is, the head unit 12 includes the flow path joint 40. The flow path joint 40 is provided at the end section of the first width direction X1 of the supply section 14 but may be provided at the end section of the second width direction X2.

The flow path joint 40 is configured to open in the downward direction Z2 but may be configured to open in any direction. The flow path joint 40 is a joint for supplying liquid and gas to the supply section 14. The flow path joint 40 can be coupled to a downstream end of the supply flow path.

The flow path joint 40 may include a liquid flow path joint 41. That is, the head unit 12 may include the liquid flow path joint 41. The liquid flow path joint 41 is a joint for coupling the liquid supply flow path 17 with the first supply flow path 22. The liquid flow path joint 41 can be coupled to the downstream end of the first supply flow path 22. The liquid flow path joint 41 may be configured to be attachable to and detachable from a tube constituting the lower end portion of the first supply flow path 22.

The first supply flow path 22 is arranged along the front-rear direction Y when coupled to the liquid flow path joint 41. The first supply flow path 22 may be arranged to extend in the forward direction Y1 when coupled to the liquid flow path joint 41.

Therefore, when the first supply flow path 22 is coupled to the liquid flow path joint 41, the first supply flow path 22 is arranged at a position not overlapping the liquid ejection head 13 in plan view. When the first supply flow path 22 is coupled to the liquid flow path joint 41, the first supply flow path 22 is arranged at a position not overlapping the relay board 31 and the plurality of wiring sections 33 in plan view.

That is, in a case where the plurality of wiring sections 33 is mounted on the head unit 12, then in plan view the plurality of wiring sections 33 does not overlap, at a position overlapping the liquid ejection head 13, the first supply flow path 22 that is coupled to the liquid flow path joint 41. When mounted on the head unit 12, the multiple wiring sections 33 do not intersect with the first supply flow path 22 that is connected to the liquid flow path joint 41.

When the relay board 31 is mounted on the head unit 12, in plan view the relay board 31 does not overlap the first supply flow path 22 coupled to the liquid flow path joint 41 at a position overlapping the liquid ejection head 13. When the relay board 31 is mounted on the head unit 12, the relay board 31 does not intersect the first supply flow path 22 coupled to the liquid flow path joint 41.

The flow path joint 40 may include a gas flow path joint 42. That is, the head unit 12 may include the gas flow path joint 42. The gas flow path joint 42 is a joint for coupling the gas supply flow path 20 with the second supply flow path 25. The gas flow path joint 42 can be coupled to a downstream end of the second supply flow path 25. The gas flow path joint 42 may be configured such that a tube constituting the lower end portion of the second supply flow path 25 is attachable to and detachable from the gas flow path joint 42.

When the second supply flow path 25 is coupled to the gas flow path joint 42, the second supply flow path 25 is arranged along the front-rear direction Y. When the second supply flow path 25 is coupled to the gas flow path joint 42, the second supply flow path 25 may be arranged so as to extend toward the forward direction Y1.

Therefore, when the second supply flow path 25 is coupled to the gas flow path joint 42, the second supply flow path 25 is arranged at a position not overlapping the liquid ejection head 13 in plan view. When the second supply flow path 25 is coupled to the gas flow path joint 42, the second supply flow path 25 is arranged at a position not overlapping the relay board 31 and the plurality of wiring sections 33 in plan view.

That is, in a case where the plurality of wiring sections 33 are mounted on the head unit 12, then in plan view, the plurality of wiring sections 33 do not overlap the second supply flow path 25 coupled to the gas flow path joint 42 at a position overlapping the liquid ejection head 13. When the head unit 12 is mounted, the plurality of wiring sections 33 does not intersect the second supply flow path 25 coupled to the gas flow path joint 42.

In a case where the relay board 31 is mounted on the head unit 12, then in plan view, the relay board 31 does not overlap the second supply flow path 25 coupled to the gas flow path joint 42 at a position overlapping the liquid ejection head 13. When the relay board 31 is mounted on the head unit 12, the relay board 31 does not intersect the second supply flow path 25 coupled to the gas flow path joint 42.

The supply section 14 includes an introduction section 43. That is, the head unit 12 includes the introduction section 43. The introduction section 43 is a portion for introducing the liquid and the gas from the flow path joint 40 into the supply section 14. Specifically, the introduction section 43 is a portion for introducing the liquid from the liquid flow path joint 41 into the supply section 14. The introduction section 43 is a portion for introducing the gas from the gas flow path joint 42 into the supply section 14. The introduction section 43 includes an upstream section of the liquid supply flow path 17 and an upstream section of the gas supply flow path 20.

As illustrated in FIG. 3, the supply section 14 is arranged at a position overlapping a part of the liquid ejection head 13 in plan view. The relay board 31 is arranged at a position overlapping a part of the liquid ejection head 13 in plan view.

The relay board 31 is arranged so as not to overlap the supply section 14 in a region overlapping a part of the liquid ejection head 13 in plan view in a case where the relay board 31 is mounted on the head unit 12. In addition, when the plurality of wiring sections 33 is mounted on the head unit 12, the plurality of wiring sections 33 do not overlap the supply section 14 in the region overlapping the liquid ejection head 13 in plan view.

In particular, the supply section 14 and the relay board 31 are provided so as to straddle a first imaginary line VL1 in plan view. The first imaginary line VL1 is an imaginary line along the width direction X. That is, the first imaginary line VL1 is an imaginary line extending in the longitudinal direction of the liquid ejection head 13.

The relay board connector 35 and the supply section 14 are arranged so as to straddle the first imaginary line VL1 in plan view. That is, as illustrated in FIG. 4, the head board connector 37 and the supply section 14 are arranged so as to straddle the first imaginary line VL1 in plan view. By this, it is possible to reduce the size of the head unit 12.

In particular, an air chamber 53 of the negative pressure release section 19 (to be described in detail later) and the head board connector 37 are arranged to straddle the first imaginary line VL1 in plan view. That is, the air chamber 53 and the relay board connector 35 are arranged to straddle the first imaginary line VL1 in plan view.

The supply section 14 and the head board connector 37 are arranged so as to straddle the second imaginary line VL2 in plan view. The second imaginary line VL2 is an imaginary line along the front-rear direction Y. That is, the second imaginary line VL2 is an imaginary line extending in a direction intersecting the longitudinal direction of the liquid ejection head 13.

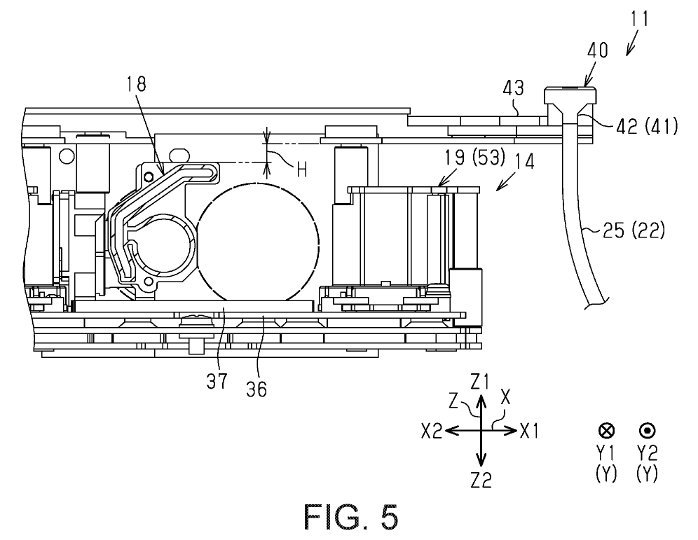

As illustrated in FIG. 5, the liquid pressure regulating valve 18 is arranged on the forward direction Y1 in front of the head board connector 37. That is, as illustrated in FIG. 4, the relay board connector 35, the head board connector 37, and the liquid pressure regulating valve 18 are provided so as to straddle the second imaginary line VL2 in plan view. By this, it is possible to reduce the size of the head unit 12.

As illustrated in FIG. 5, in the supply section 14, the liquid pressure regulating valve 18 and the negative pressure release section 19 are arranged to be aligned in the width direction X. In particular, in the supply section 14, the air chamber 53 of the negative pressure release section 19 is arranged at a position overlapping at least a part of the liquid pressure regulating valve 18 when viewed from the longitudinal direction. The liquid pressure regulating valve 18 is arranged inside the negative pressure release section 19 in the width direction X.

The negative pressure release section 19 is arranged so as to be higher than the liquid pressure regulating valve 18 by a height H in the vertical direction Z. The liquid pressure regulating valve 18 may be arranged so as to be higher than the negative pressure release section 19 in the vertical direction Z. The liquid pressure regulating valve 18 and the negative pressure release section 19 may be arranged at the same height in the vertical direction Z.

The gas flow path joint 42 is open to the downward direction Z2. The gas flow path joint 42 is arranged at a position higher than the introduction section 43. The lower end portion of the second supply flow path 25 is coupled to the gas flow path joint 42 from the downward direction Z2. When the second supply flow path 25 is coupled to the gas flow path joint 42, the second supply flow path 25 is routed to the forward direction Y1 so as to be curved to the downward direction Z2.

The liquid flow path joint 41 is open to the downward direction Z2. The liquid flow path joint 41 is arranged at a position higher than the introduction section 43. By this, dripping of liquid from the liquid flow path joint 41, when the lower end portion of the first supply flow path 22 is detached from the liquid flow path joint 41, can be suppressed.

The lower end portion of the first supply flow path 22 is coupled to the liquid flow path joint 41 from the downward direction Z2. When the first supply flow path 22 is coupled to the liquid flow path joint 41, the first supply flow path 22 is routed to the forward direction Y1 so as to curve to the downward direction Z2.

By this, the first supply flow path 22 can be detached from the liquid flow path joint 41 in a state where the lower end portion of the first supply flow path 22 faces the upward direction Z1. Therefore, when the lower end portion of the first supply flow path 22 is detached from the liquid flow path joint 41, it is possible to suppress the liquid from dripping from the lower end portion of the first supply flow path 22.

In addition, the relay board 31 and the plurality of wiring sections 33 are not arranged on the downward direction Z2 of the liquid flow path joint 41. In particular, the plurality of wiring connectors 34, the relay board connector 35, and the head board connector 37 are not arranged on the downward direction Z2 of the liquid flow path joint 41, and thus safety can be improved.

### Configuration of negative pressure release section 19

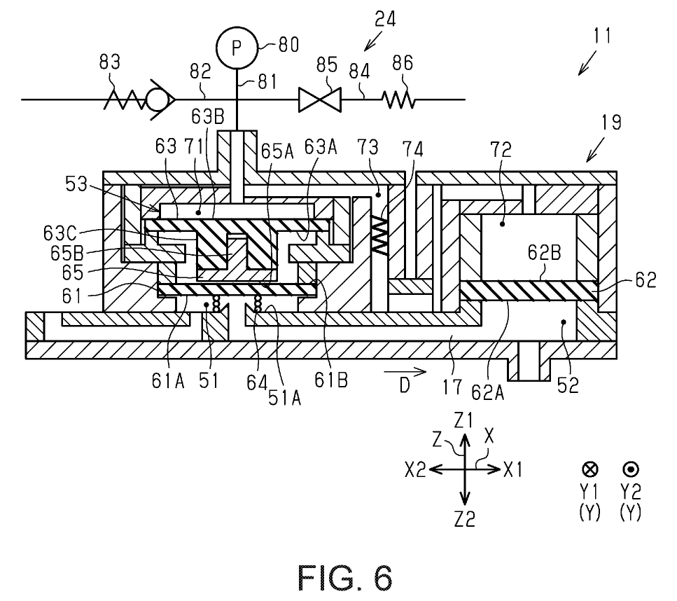

As illustrated in FIG. 6, the negative pressure release section 19 includes a first liquid chamber 51, a second liquid chamber 52, and the air chamber 53. The first liquid chamber 51 is provided in the liquid supply flow path 17. The first liquid chamber 51 is provided upstream of the liquid ejection head 13 in the liquid supply flow path 17. The first liquid chamber 51 is provided downstream of the liquid pressure regulating valve 18 in the liquid supply flow path 17. That is, the liquid pressure regulating valve 18 is provided upstream of the first liquid chamber 51.

The first liquid chamber 51 includes a first flexible member 61. The first flexible member 61 has elasticity. The first flexible member 61 is a resin member having elasticity, but may be any material, and may be a film having elasticity.

The first flexible member 61 is deformed in accordance with the pressure of a first air chamber 71 (to be described later). The first flexible member bis deformed in accordance with deformation of a third flexible member 63 (to be described later). The first flexible member 61 is pressed by a pressing member 65 (to be described later) and is deformed in accordance with the deformation of the third flexible member 63.

The first flexible member 61 includes a first surface 61A and a second surface 61B. The first surface 61A and the second surface 61B are surfaces intersecting the vertical direction Z. The first surface 61A is a surface on the first liquid chamber 51 side. The first surface 61A is a surface that receives the liquid pressure from the first liquid chamber 51. The second surface 61B is a surface on the side of the first air chamber 71 side (to be described later).

The first flexible member 61 is capable of opening and closing the liquid supply flow path 17 by being deformed. The first flexible member 61 closes the first liquid chamber 51 by bending toward the first liquid chamber 51 against the biasing force from a biasing member 64 (to be described later) in response to the pressurization of the first air chamber 71. The first flexible member 61 opens the first liquid chamber 51 by, in response to stopping the pressurization of the first air chamber 71, returning to the position where the first flexible member 61 is not bent.

The first liquid chamber 51 includes the biasing member 64. The biasing member 64 may be arranged between the first surface 61A of the first flexible member 61 and an inner wall surface 51A of the first liquid chamber 51. The biasing member 64 biases the first flexible member 61 toward the first air chamber 71. In this way, the biasing member 64 can increase the opening response of the first liquid chamber 51.

The second liquid chamber 52 is arranged in the liquid supply flow path 17. The second liquid chamber 52 is arranged upstream of the liquid ejection head 13 in the liquid supply flow path 17. The second liquid chamber 52 is arranged downstream of the first liquid chamber 51 in the liquid supply flow path 17. The second liquid chamber 52 may have a capacity corresponding to the ejection amount of liquid to be ejected for cleaning.

The second liquid chamber 52 includes a second flexible member 62. The second flexible member 62 has elasticity. The second flexible member 62 is a resin member having elasticity, but may be any material, and may be a film having elasticity.

The second flexible member 62 is deformed in accordance with the pressure of a second air chamber 72 (to be described later). The second flexible member 62 pressurizes the second liquid chamber 52 by bending toward the second liquid chamber 52 in accordance with the pressurization of the second air chamber 72. The second flexible member 62 decompresses the second liquid chamber 52 by, in response to stopping pressurization of the second air chamber 72, returning to a position where the second flexible member 62 is not bent.

The second flexible member 62 includes a first surface 62A and a second surface 62B. The first surface 62A and the second surface 62B are surfaces intersecting the vertical direction Z. The first surface 62A is a surface on the second liquid chamber 52 side. The first surface 62A is a surface that receives the liquid pressure from the second liquid chamber 52. The second surface 62B is a surface on the second air chamber 72 side (to be described later). The second surface 62B is a surface that receives the air pressure from the second air chamber 72.

The hardness of the second flexible member 62 is greater than the hardness of the first flexible member 61. That is, the hardness of the first flexible member 61 is equal to or less than the hardness of the second flexible member 62. The hardness of the second flexible member 62 may be less than the hardness of the first flexible member 61, and the hardness of the second flexible member 62 may be the same as the hardness of the first flexible member 61.

The air chamber 53 is coupled to the air pressure regulating section 24. Specifically, the air chamber 53 is connected to a downstream end of the first air flow path 81 (to be described later). Air is supplied from the air pressure regulating section 24 to the air chamber 53. The negative pressure release section 19 can be driven by supplying air from the air pressure regulating section 24 to the air chamber 53.

The air chamber 53 includes a first air chamber 71, the second air chamber 72, and a communication flow path 73. The air pressure regulating section 24 is coupled to the first air chamber 71. Specifically, a downstream end of the first air flow path 81 (to be described later) is coupled to the first air chamber 71. The first air chamber 71 is a region for deforming the first flexible member 61. The first air chamber 71 may be arranged at a position overlapping the first liquid chamber 51 in the vertical direction Z. The first air chamber 71 may be arranged coaxially with the first liquid chamber 51 in the vertical direction Z.

The first air chamber 71 includes the third flexible member 63. The first air chamber 71 may include the pressing member 65. The third flexible member 63 has elasticity. The third flexible member 63 may be a resin member having elasticity. The third flexible member 63 deforms in accordance with the pressure of the first air chamber 71. The third flexible member 63 is a member for deforming the first flexible member 61.

The third flexible member 63 includes a first surface 63A and a second surface 63B. The first surface 63A and the second surface 63B are surfaces intersecting the vertical direction Z. The first surface 63A is a surface on the first flexible member 61 side. The first surface 63A may be a surface of the first flexible member 61 facing the first surface 61A. The second surface 63B is a surface on the air pressure regulating section 24 side. The second surface 63B is a surface that receives the air pressure from the first air chamber 71.

The diameter of the third flexible member 63 is larger than the diameter of the first flexible member 61. That is, the diameter of the first flexible member 61 is smaller than the diameter of the third flexible member 63 but may be larger than the diameter of the third flexible member 63, or may be the same as the diameter of the third flexible member 63. The first flexible member 61 has a smaller pressure receiving area than the third flexible member 63.

The third flexible member 63 may be arranged so as to be centered on the same axis as the first flexible member 61 in the vertical direction Z. That is, the first flexible member 61 and the third flexible member 63 may be arranged to have the same axis as a center, in the vertical direction Z. In other words, at least a portion of the first flexible member 61 may be arranged so as to overlap the third flexible member 63 in plan view.

The third flexible member 63 may include a holding section 63C. The holding section 63C may be configured to protrude from the first surface 63A toward the downward direction Z2. The holding section 63C is configured to hold the pressing member 65. The holding section 63C may include a recess section for holding the pressing member 65.

The pressing member 65 is arranged between the first flexible member 61 and the third flexible member 63. The pressing member 65 includes a pressing surface 65A. The pressing surface 65A is a surface that faces the downward direction Z2. The pressing surface 65A is a surface that faces the first flexible member 61. The pressing surface 65A contacts with the second surface 61B of the first flexible member 61.

The pressing member 65 includes a protruding section 65B. The protruding section 65B may be configured to protrude in upward direction Z1. The protruding section 65B may be configured to protrude toward the third flexible member 63. The protruding section 65B may be configured to protrude towards the holding section 63C. The protruding section 65B is held by the holding section 63C of the third flexible member 63.

By this, the pressing member 65 moves in the vertical direction Z in accordance with the deformation of the third flexible member 63. The pressing member 65 moves toward the downward direction Z2 as the third flexible member 63 bends toward the downward direction Z2. In this case, the pressing member 65 bends the first flexible member 61 in the downward direction Z2 by pressing the first flexible member 61 in the downward direction Z2.

The pressing member 65 moves in the upward direction Z1 as the third flexible member 63 returns to the undeflected position. In this case, the pressing member 65 returns to a position where the first flexible member 61 does not bend as the pressing force in the downward direction Z2 on the first flexible member 61 is released.

The second air chamber 72 is configured to communicate with the first air chamber 71 via the communication flow path 73. The second air chamber 72 is a region for deforming the second flexible member 62. The volume of the second air chamber 72 is larger than the volume of the first air chamber 71 but may be smaller than the volume of the first air chamber 71 or may be the same as the volume of the first air chamber 71.

The communication flow path 73 is coupled to the first air chamber 71 and the second air chamber 72. The communication flow path 73 includes a first resistance flow path 74. That is, the first resistance flow path 74 is coupled to the first air chamber 71 and the second air chamber 72. The first resistance flow path 74 is a flow path having resistance to the flow of the gas in the communication flow path 73. The first resistance flow path 74 delays the flow of gas between the first air chamber 71 and the second air chamber 72.

The air pressure regulating section 24 is configured to adjust the pressure of the air chamber 53. The air pressure regulating section 24 includes a pump 80, a first air flow path 81, a second air flow path 82, a regulator 83, an atmosphere release flow path 84, and an atmosphere release valve 85.

The pump 80 is a pressurizing pump that pressurizes the air chamber 53. The pump 80 is provided at an upstream end of the first air flow path 81. The downstream end of the first air flow path 81 is coupled to the air chamber 53. The first air flow path 81 is a flow path that couples the pump 80 with the air chamber 53.

The second air flow path 82 is a flow path for adjusting the pressure of the air chamber 53. The regulator 83 is coupled to an upstream end of the second air flow path 82. The downstream end of the second air flow path 82 is coupled to the first air flow path 81. The downstream end of the second air flow path 82 is coupled to the first air flow path 81 between the pump 80 and the air chamber 53. The regulator 83 adjusts the pressure of the air chamber 53. The regulator 83 is controlled by the control section 29 so as to adjust the pressure of the air chamber 53.

The atmosphere release flow path 84 is a flow path for opening the first air flow path 81 to atmosphere. The downstream end of the atmosphere release flow path 84 is coupled to the first air flow path 81. The downstream end of the atmosphere release flow path 84 is coupled between the pump 80 and the air chamber 53.

The atmosphere release flow path 84 includes the atmosphere release valve 85. The atmosphere release valve 85 is provided in the atmosphere release flow path 84. The atmosphere release valve 85 is controlled by the control section 29 so as to be openable and closable. The atmosphere release flow path 84 includes a second resistance flow path 86. The second resistance flow path 86 is arranged upstream of the atmosphere release valve 85 in the atmosphere release flow path 84. The resistance of the second resistance flow path 86 is smaller than the resistance of the first resistance flow path 74. That is, the resistance of the first resistance flow path 74 is larger than the resistance of the second resistance flow path 86.

### Cleaning process

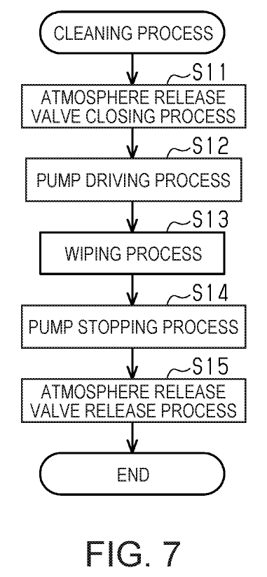

Here, a cleaning process will be described with reference to FIG. 7. The cleaning process is executed by the control section 29 when a cleaning condition is satisfied. The cleaning condition is satisfied when cleaning of the liquid ejection head 13 is performed.

The cleaning condition may be satisfied when a missing nozzle of the liquid ejection head 13 is detected. The cleaning condition may be satisfied based on the number of printed sheets. The cleaning condition may be satisfied when a predetermined time has elapsed. The cleaning condition may be satisfied at a predetermined cycle. The cleaning condition may be satisfied in response to an instruction from the user.

As illustrated in FIG. 7, in step S11, the control section 29 executes an atmosphere release valve closing process. In this process, the control section 29 closes the atmosphere release valve 85. By this, the air chamber 53 is not open to atmosphere.

In step S12, the control section 29 executes a pump driving process. In this process, the control section 29 drives the pump 80. By this, the air chamber 53 is pressurized in a state where the air chamber 53 is not open to atmosphere.

In this way, in the negative pressure release section 19, the first air chamber 71 is pressurized by driving the pump 80. When the first air chamber 71 is pressurized, the third flexible member 63 is bent toward the first flexible member 61, and the pressing member 65 moves toward the first flexible member 61. By this, the first flexible member 61 is bent toward the first liquid chamber 51 and closes the liquid supply flow path 17.

In particular, the first flexible member 61 has a smaller pressure receiving area than the third flexible member 63. Therefore, the third flexible member 63 is more easily bent than the first flexible member 61, and the closing response of the first liquid chamber 51 can be accelerated.

When the first air chamber 71 is pressurized by driving the pump 80, the second air chamber 72 is also pressurized via the communication flow path 73. When the second air chamber 72 is pressurized, the second flexible member 62 is bent toward the second liquid chamber 52 and pressurizes the liquid supply flow path 17.

In particular, the second air chamber 72 is pressurized later than the first air chamber 71 by the first resistance flow path 74 provided in the communication flow path 73. The second air chamber 72 has a larger capacity than the first air chamber 71. The hardness of the second flexible member 62 is greater than the hardness of the first flexible member 61.

Therefore, the second flexible member 62 is less likely to be bent than the first flexible member 61. By this, the second liquid chamber 52 is pressurized after the liquid supply flow path 17 is closed by the first flexible member 61. Therefore, by appropriately pressurizing the second liquid chamber 52, an appropriate ejection amount of liquid is supplied to the liquid ejection head 13.

In step S13, the control section 29 executes the wiping process. In this process, the control section 29 adjusts to maintain the air pressure of the air chamber 53. Specifically, the control section 29 may control the pump 80 so as to maintain the air pressure of the air chamber 53 using a check valve built in the pump 80. By this, in a state where the air chamber 53 is not open to atmosphere, the air pressure of the air chamber 53 is maintained.

Thereafter, the control section 29 controls the wiping section 26 so as to wipe the nozzle surface 16. By this, after the cleaning, the liquid remaining on the nozzle surface 16 is wiped by the wiping section 26.

In step S14, the control section 29 executes a pump stopping process. In this process, the control section 29 stops the driving of the pump 80.

In step S15, the control section 29 executes the atmosphere release valve opening process. In this process, the control section 29 opens the atmosphere release valve 85. By this, the air chamber 53 is open to atmosphere.

In this manner, in the negative pressure release section 19, when the driving of the pump 80 is stopped and the first air chamber 71 is open to atmosphere, the first air chamber 71 is depressurized. When the first air chamber 71 is depressurized, the third flexible member 63 returns to a position where the third flexible member 63 is not bent, and the pressing member 65 moves in the opposite direction from the first flexible member 61 side. By this, the first flexible member 61 receives the liquid pressure from the first liquid chamber 51, returns to a position where it is not bent, and opens the liquid supply flow path 17.

In particular, the first flexible member 61 has a smaller pressure receiving area than the third flexible member 63. Therefore, it is possible to suppress self-choke of the liquid supply flow path 17. In addition, the first flexible member 61 returns to the position where the first flexible member 61 is not bent even by the biasing force of the biasing member 64. Therefore, the opening response of the first liquid chamber 51 can be accelerated.

When the first air chamber 71 is depressurized, the second air chamber 72 is also depressurized via the communication flow path 73. When the second air chamber 72 is depressurized, the second flexible member 62 returns to a position where the second flexible member 62 is not bent, and the liquid supply flow path 17 is depressurized.

In particular, the second air chamber 72 is depressurized later than the first air chamber 71 by the first resistance flow path 74 provided in the communication flow path 73. The second air chamber 72 has a larger capacity than the first air chamber 71. The hardness of the second flexible member 62 is greater than the hardness of the first flexible member 61.

Therefore, the second flexible member 62 is less likely to return to the position where the second flexible member 62 is not bent than is the first flexible member 61. By this, the second liquid chamber 52 is depressurized after the liquid supply flow path 17 is opened by the first flexible member 61. Therefore, by appropriately decompressing the second liquid chamber 52, the meniscus of the nozzles 15 can be set to an appropriate state.

### Operation and effects of the first embodiment

The operation and effects of the first embodiment will be described.

(1-1) In the related art, the control for pressurizing the liquid ejection head 13 had become complicated. Therefore, in the present embodiment, the air chamber 53 includes the first air chamber 71 to which the air pressure regulating section 24 is connected, the second air chamber 72, and the first resistance flow path 74, which is connected to the first air chamber 71 and the second air chamber 72. The first liquid chamber 51 includes the first flexible member 61 that can open and close the liquid supply flow path 17 by deforming according to the pressure of the first air chamber 71. The second liquid chamber 52 includes the second flexible member 62 that deforms in accordance with the pressure of the second air chamber 72.

According to this configuration, the first resistance flow path 74 can improve the reliability of deforming the first flexible member 61 in accordance with the pressure of the first air chamber 71 before deforming the second flexible member 62 in accordance with the pressure of the second air chamber 72. Therefore, it is possible to simplify the control for pressurizing the liquid ejection head 13.

In addition, the deformation timing of the first flexible member 61 and the deformation timing of the second flexible member 62 can be adjusted without providing a configuration for controlling the pressures of the first air chamber 71 and the second air chamber 72. Therefore, space saving can be achieved. In particular, by simplifying the configuration of the air pressure regulating section 24, such as the number of valves, the number of components can be reduced, and space saving and weight reduction can be achieved.

Both the air pressure of the first air chamber 71 and the air pressure of the second air chamber 72 can be controlled. Therefore, the number of the second supply flow path 25 coupled to the head unit 12 can also be reduced.

(1-2) The liquid ejection device 11 includes the biasing member 64 that biases the first flexible member 61 toward the first air chamber 71. According to this configuration, it is possible to improve the certainty of the deformation of the first flexible member 61 from the position where the first flexible member 61 is bent toward the first liquid chamber 51 to the position where the first flexible member 61 is not bent, and to accelerate the deformation response of the first flexible member 61 to the position where the first flexible member 61 is not bent.

(1-3) The first air chamber 71 includes the third flexible member 63 that deforms in accordance with the pressure in the first air chamber 71. The first flexible member 61 is deformed in accordance with the deformation of the third flexible member 63. The diameter of the first flexible member 61 is smaller than the diameter of the third flexible member 63. According to this configuration, the first flexible member 61 can be deformed in accordance with the deformation of the third flexible member 63, which has a larger diameter than the first flexible member 61. Therefore, by using the third flexible member 63, which has a large pressure receiving area from the first air chamber 71, it is possible to improve the certainty of the deformation of the first flexible member 61 and to accelerate the deformation response of the first flexible member 61.

(1-4) At least a portion of the first flexible member 61 overlaps the third flexible member 63 in plan view. According to this configuration, the first flexible member 61 can be efficiently deformed in accordance with the deformation of the third flexible member 63, and space saving can be achieved.

(1-5) The first flexible member 61 and the third flexible member 63 are provided to be centered on the same axis in plan view. According to this configuration, the first flexible member 61 can be deformed more efficiently in accordance with the deformation of the third flexible member 63, and space saving can be achieved.

(1-6) The hardness of the first flexible member 61 is equal to or less than the hardness of the second flexible member 62. According to this configuration, the deformation response of the first flexible member 61 can be faster than that of the second flexible member 62. Therefore, it is possible to improve the certainty of deforming the first flexible member 61 before deforming the second flexible member 62.

(1-7) The volume of the second air chamber 72 is larger than the volume of the first air chamber 71. According to this configuration, the deformation response of the first flexible member 61 can be faster than that of the second flexible member 62. Therefore, it is possible to improve the certainty of deforming the first flexible member 61 before deforming the second flexible member 62.

(1-8) The air pressure regulating section 24 includes the pump 80, the first air flow path 81 that connects the pump 80 and the first air chamber 71, and the atmosphere release flow path 84 for opening the first air flow path 81 to atmosphere. The atmosphere release flow path 84 includes the atmosphere release valve 85 and the second resistance flow path 86 upstream of the atmosphere release valve 85. According to this configuration, the release speed of the first air chamber 71 to atmosphere can be reduced. By this, the speed at which the first flexible member 61 returns to the unbent position and the speed at which the second flexible member 62 returns to the unbent position can be reduced. Therefore, the menisci of the nozzles 15 can be brought into an appropriate state.

(1-9) The resistance of the first resistance flow path 74 is greater than the resistance of the second resistance flow path 86. According to this configuration, the deformation response of the first flexible member 61 can be faster than that of the second flexible member 62. Therefore, it is possible to improve the certainty of deforming the first flexible member 61 before deforming the second flexible member 62.

(1-10) The liquid pressure regulating valve 18 is provided upstream of the first liquid chamber 51 in the supply direction D. According to this configuration, it is possible to pressurize the liquid ejection head 13 between the liquid pressure regulating valve 18 and the liquid ejection head 13.

(1-11) The air chamber 53 is arranged at a position overlapping at least a part of the liquid pressure regulating valve 18 when viewed from the longitudinal direction. According to this configuration, the air chamber 53 and the liquid pressure regulating valve 18 can be efficiently arranged. Therefore, space saving can be achieved.

(1-12) The air chambers 53, and the relay board connector 35 and the head board connector 37, which are for driving the liquid ejection head 13, are provided at positions straddling the first imaginary line VL1 that extends in the longitudinal direction in plan view. According to this configuration, the air chamber 53, the relay board connector 35, and the head board connector 37 can be efficiently arranged. Therefore, space saving can be achieved.

(2-1) In the related art, it is desired to improve the workability of detaching the plurality of wiring sections 33 when performing maintenance of the liquid ejection head 13. Here, when the plurality of wiring sections 33 are mounted on the head unit 12, the plurality of wiring sections 33 do not overlap the supply flow path, which is connected to the flow path joint 40, at a position overlapping the liquid ejection head 13. According to this configuration, when performing maintenance of the liquid ejection head 13, it is possible to independently perform the removal of the plurality of wiring sections 33 from the head unit 12 and the removal of the supply flow path from the flow path joint 40. Therefore, the workability can be improved.

(2-2) The relay board 31 is attachable to and detachable from the head unit 12. The plurality of wiring sections 33 are attachable to and detachable from the relay board 31. In a plan view, when the relay board 31 is mounted on the head unit 12, the relay board 31 does not overlap the supply flow path coupled to the flow path joint 40 at a position overlapping the liquid ejection head 13. According to this configuration, when performing maintenance on the liquid ejection head 13, the relay board 31 can be removed from the head unit 12 and the supply flow path can be removed from the flow path joint 40 independently. Therefore, the workability can be improved.

In addition, the plurality of wiring sections 33 can be removed from the head unit 12 by removing the relay board 31 from the head unit 12. Therefore, the workability can be improved.

(2-3) In a plan view, the relay board 31 does not overlap the supply section 14 for supplying the liquid to the liquid ejection head 13 at the position overlapping the liquid ejection head 13. According to this configuration, the relay board 31 on which the plurality of wiring sections 33 is mounted can be handled so as not to overlap the supply section 14. By this, when the relay board 31 is attached to or detached from the head unit 12, the relay board 31 can be handled so as not to collide with the supply section 14. Therefore, the workability can be improved.

(2-4) The relay board 31 and the supply section 14 are provided at positions straddling the first imaginary line VL1 extending in the longitudinal direction in plan view. According to this configuration, the relay board 31 and the supply section 14 can be efficiently arranged. Therefore, space saving can be achieved.

(2-5) The head unit 12 includes the flow path joint 40 having the liquid flow path joint 41, to which the downstream end of the first supply flow path 22 can be attached and detached, and the gas flow path joint 42, to which the downstream end of the second supply flow path 25 can be attached and detached. According to this configuration, even when the first supply flow path 22 is coupled to the liquid flow path joint 41 and the second supply flow path 25 is coupled to the gas flow path joint 42, it is possible to improve workability.

### SECOND EMBODIMENT

Next, a second embodiment will be described. In the following description, redundant descriptions of configurations identical to those of the previously described embodiment will be omitted or simplified, and configurations that differ from the previously described embodiment will be detailed.

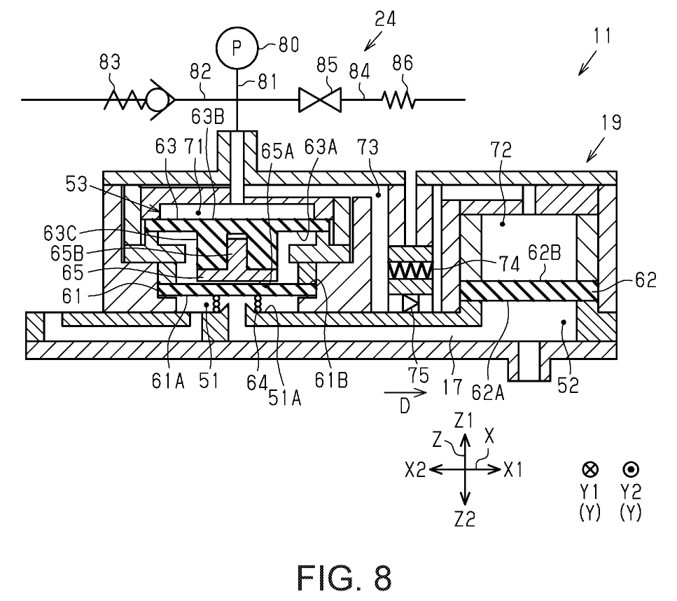

As illustrated in FIG. 8, in the second embodiment, the communication flow path 73 may have different flow path resistances between the flow path from the first air chamber 71 to the second air chamber 72 and the flow path from the second air chamber 72 to the first air chamber 71. The communication flow path 73 may be provided with a one-way valve 75 in a flow path parallel to the first resistance flow path 74. The one-way valve 75 is configured to allow gas to flow out from the first air chamber 71 to the second air chamber 72. That is, it may be configured so that the gas from the first air chamber 71 to the second air chamber 72 does not flow through the first resistance flow path 74 and so that the gas from the second air chamber 72 to the first air chamber 71 flows through the first resistance flow path 74. By this, it is possible to appropriately adjust the flow of gas between the first air chamber 71 and the second air chamber 72. The one-way valve 75 may be configured to be flush with the first resistance flow path 74.

### MODIFICATIONS

The present embodiment can be implemented with the following modifications. The present embodiments and the following modifications can be implemented in combination with each other as long as there is no technical contradiction.

In the second embodiment, the one-way valve 75 may be configured to allow the gas to flow out from the second air chamber 72 to the first air chamber 71. That is, it may be configured so that the gas from the second air chamber 72 to the first air chamber 71 does not flow through the first resistance flow path 74 and so that the gas from the first air chamber 71 to the second air chamber 72 flows through the first resistance flow path 74.

The control section 29 may control the regulator 83 so as to adjust the pressure of the air chamber 53. For example, in step S13, the control section 29 may stop drive of the pump 80 and control the regulators 83 to maintain the air pressure of the air chamber 53. The regulator 83 may be the same valve as the atmosphere release valve 85. That is, the regulator 83 may include a mechanism for opening the regulator 83 to atmosphere.

The negative pressure release section 19 is configured to be driven by pressurization from the pump 80, but this is not a limitation. For example, the negative pressure release section 19 may be configured to operate by depressurization from the pump 80.

The negative pressure release section 19 may be configured to operate by pressurization from the liquid pressure regulating valve 18. In the liquid ejection device 11, the liquid pressure regulating valve 18 may not be arranged upstream of the negative pressure release section 19. The liquid ejection device 11 may not include the liquid pressure regulating valve 18.

The diameter of the first flexible member 61 may be smaller than the diameter of the second flexible member 62. The diameter of the first flexible member 61 may be larger than the diameter of the second flexible member 62. The diameter of the first flexible member 61 may be the same as the diameter of the second flexible member 62.

The plurality of wiring sections 33 may be any wiring member other than the flexible flat cable. The plurality of wiring sections 33 may be universal serial bus (USB) cables.

The flow path joint 40 may include either the liquid flow path joint 41 or the gas flow path joint 42. The liquid flow path joint 41 may be couplable to at least one first supply flow path 22. The gas flow path joint 42 may be couplable to at least one second supply flow path 25.

A lateral printer may be adopted as the liquid ejection device 11. A lateral type printer is a printer in which a carriage on which the liquid ejection head 13 is mounted is movable in two directions of the width direction X and the front-rear direction Y. The liquid ejection head 13 may be configured to eject the liquid so as to be inclined with respect to the vertical direction Z.

The medium 99 may be any medium including, but not limited to, paper sheet, roll body, resin film or sheet, composite film comprising resin and metal, laminate film, woven fabric, nonwoven fabric, metal foil, metal film, ceramic sheet, or fabric for clothing.

The liquid may be arbitrarily selected as long as the liquid can be printed on the medium 99 by adhering to the medium 99. The liquid may be a dye ink such as a disperse dye ink or a reactive dye ink. For example, the ink includes an ink in which particles of functional material made of solid material such as pigment or metal particles are dissolved, dispersed, or mixed in a solvent, and includes various compositions such as water-based ink, oil-based ink, gel ink, and hot-melt ink.

As used herein, the phrase "at least any" means one or more of the desired options. As an example, the phrase "at least any of" as used herein means only one option if the number of options is two, or both of the two options. As another example, the phrase "at least any" as used herein means only one option or a combination of any two or more options if the number of options is three or more.

### APPENDIX

Hereinafter, technical ideas grasped from the above-described embodiment and modifications, and operations and effects thereof will be described. The present technical ideas and operational effects thereof can be combined with each other within a technically consistent range.

[1-1] A liquid ejection device includes a liquid ejection head configured to eject a liquid; a liquid supply flow path configured to supply liquid to the liquid ejection head; a first liquid chamber arranged in the liquid supply flow path; a second liquid chamber arranged in the liquid supply flow path; an air chamber configured to be supplied with air; an air pressure regulating section that adjusts a pressure of the air chamber, wherein the first liquid chamber is arranged upstream of the liquid ejection head in a supply direction in which the liquid is supplied to the liquid ejection head, the second liquid chamber is arranged upstream of the liquid ejection head in the supply direction and downstream of the first liquid chamber in the supply direction, the air chamber includes a first air chamber coupled with the air pressure regulating section, a second air chamber, and a first resistance flow path coupled to the first air chamber and the second air chamber, the first liquid chamber includes a first flexible member configured to open and close the liquid supply flow path by deforming in response to the pressure of the first air chamber, and the second liquid chamber includes a second flexible member that deforms in accordance with a pressure of the second air chamber.

According to this configuration, the first resistance flow path can improve the certainty of deforming the first flexible member in accordance with the pressure of the first air chamber before deforming the second flexible member in accordance with the pressure of the second air chamber. Therefore, it is possible to simplify the control for pressurizing the liquid ejection head.

In addition, the deformation timing of the first flexible member and the deformation timing of the second flexible member can be adjusted without providing a configuration for controlling the pressures of the first air chamber and the second air chamber, respectively. Therefore, space saving can be achieved.

[1-2] The liquid ejection device described above may further include a biasing member that biases the first flexible member toward the first air chamber.

According to this configuration, it is possible to improve the certainty of deformation of the first flexible member from a bent position toward the first liquid chamber to an unbent position, and to increase the speed of the deformation response of the first flexible member toward the unbent position.

[1-3] The liquid ejection device described above may be such that the first air chamber includes a third flexible member that deforms in accordance with a pressure in the first air chamber and the first flexible member deforms in accordance with deformation of the third flexible member, and a diameter of the first flexible member is smaller than a diameter of the third flexible member.

According to this configuration, the first flexible member can be deformed in accordance with the deformation of the third flexible member, which has a larger diameter than the first flexible member. Therefore, by using the third flexible member having a larger pressure receiving area for receiving pressure from the first air chamber, this configuration enables improving the certainty of deformation of the first flexible member and increasing the speed of its deformation response.

[1-4] The liquid ejection device described above may be such that at least a portion of the first flexible member overlaps the third flexible member, when viewed from a first direction intersecting a first surface of the first flexible member.

According to this configuration, the first flexible member can be efficiently deformed in accordance with the deformation of the third flexible member, and space saving can be achieved.

[1-5] The liquid ejection device described above may be such that the first flexible member and the third flexible member are arranged to be centered on the same axis in the first direction.

According to this configuration, the first flexible member can be deformed more efficiently in accordance with the deformation of the third flexible member, and space saving can be achieved.

[1-6] The liquid ejection device described above may be such that the hardness of the first flexible member is equal to or less than the hardness of the second flexible member.

According to this configuration, the deformation response of the first flexible member can be faster than the deformation response of the second flexible member. Therefore, it is possible to improve the certainty of deforming the first flexible member before deforming the second flexible member.

[1-7] The liquid ejection device described above may be such that the volume of the second air chamber is larger than the volume of the first air chamber.

According to this configuration, the deformation response of the first flexible member can be faster than the deformation response of the second flexible member. Therefore, it is possible to improve the certainty of deforming the first flexible member before deforming the second flexible member.

[1-8] The liquid ejection device described above may be such that the air pressure regulating section includes a pump, a first air flow path that couples the pump with the first air chamber, an air open flow path that opens the first air flow path to atmosphere, and the air open flow path includes an air open valve and a second resistance flow path arranged upstream the air open valve.

According to this configuration, the speed at which the first air chamber is open to atmosphere can be reduced. By this, the speed of the return of the first flexible member to the position where the first flexible member is not bent and the speed of the return of the second flexible member to the position where the second flexible member is not bent can be reduced. Therefore, the meniscus of the nozzle can be set to an appropriate state.

[1-9] The liquid ejection device described above may be such that a resistance of the first resistance flow path is greater than a resistance of the second resistance flow path.

According to this configuration, the deformation response of the first flexible member can be faster than the deformation response of the second flexible member. Therefore, it is possible to improve the certainty of deforming the first flexible member before deforming the second flexible member.

[1-10] The liquid ejection device described above may be such that a liquid pressure regulating valve is provided upstream of the first liquid chamber in the supply direction.

According to this configuration, it is possible to pressurize the liquid ejection head between the liquid pressure regulating valve and the liquid ejection head.

[1-11] The liquid ejection device described above may be such that the liquid ejection head is a line head extending in a longitudinal direction and the air chamber is arranged at a position overlapping at least a part of the liquid pressure regulating valve when viewed from the longitudinal direction.

According to this configuration, the air chamber and the liquid pressure regulating valve can be efficiently arranged. Therefore, space saving can be achieved.

[1-12] The liquid ejection device described above may include a circuit board having a connector for driving the liquid ejection head, wherein the liquid ejection head is a line head that ejects a liquid in a ejection direction and that extends in a longitudinal direction intersecting the ejection direction, the air chamber and the connector are arranged at positions straddling an imaginary line extending in the longitudinal direction when viewed from the ejection direction.

According to this configuration, the air chamber and the connector can be efficiently arranged. Therefore, space saving can be achieved.

[2-1] A liquid ejection device includes a head unit including a liquid ejection head that ejects liquid in an ejection direction and a plurality of wiring sections that are attachable to and detachable from the head unit and that supply electric signals to the liquid ejection head, wherein the head unit includes a flow path joint configured to couple to a downstream end of a supply flow path for supplying liquid to the liquid ejection head, the liquid ejection head is a line head extending in a longitudinal direction that intersects the ejection direction, and when viewed from the ejection direction while the plurality of wiring sections are mounted to the head unit, the wiring sections do not overlap with the supply flow path coupled to the flow path joint at a position where the wiring sections overlap with the liquid ejection head.

According to this configuration, the plurality of wiring sections mounted on the head unit and the supply flow path connected to the flow path joint do not overlap each other at a position overlapping the liquid ejection head when viewed from the ejection direction. Therefore, when maintenance of the liquid ejection head is performed, it is possible to independently perform the removal of the plurality of wiring sections from the head unit and the removal of the supply flow path from the flow path joint. Therefore, the workability can be improved.

[2-2] The liquid ejection device may further include a relay board that is attachable to and detachable from the head unit and that is configured such that the plurality of wiring sections is detachably attached thereto, wherein when viewed from the ejection direction and when the relay board is mounted on the head unit, the relay board does not overlap the supply flow path coupled to the flow path joint at a position overlapping the liquid ejection head.

According to this configuration, the relay board mounted on the head unit and the supply flow path connected to the flow path joint do not overlap each other at a position overlapping the liquid ejection head when viewed from the ejection direction. Therefore, when performing maintenance of the liquid ejection head, it is possible to independently perform the removal of the relay board from the head unit and the removal of the supply flow path from the flow path joint. In addition, the plurality of wiring sections can be detached from the head unit by detaching the relay board from the head unit. Therefore, the workability can be improved.

[2-3] The liquid ejection device described above may be such that the head unit includes a supply section for supplying liquid to the liquid ejection head, the supply section includes the flow path joint, and when viewed from the ejection direction, the relay board does not overlap the supply section at a position overlapping the liquid ejection head.

According to this configuration, the relay board on which the plurality of wiring sections are mounted can be handled so as not to overlap the supply section. By this, when the relay board is attached to or detached from the head unit, the relay board can be handled so as not to collide with the supply section. Therefore, the workability can be improved.

[2-4] The liquid ejection device described above may be such that when viewed from the ejection direction, the relay board and the supply section are arranged at positions straddling an imaginary line extending in the longitudinal direction.

According to this configuration, the relay board and the supply section can be efficiently arranged. Therefore, space saving can be achieved.

[2-5] The liquid ejection device described above may be such that the flow path joint is a liquid flow path joint to which a downstream end of a first supply flow path for supplying liquid to the liquid ejection head is detachably attached and the head unit includes a gas flow path joint to which a downstream end of a second supply flow path for supplying a gas to deliver liquid to the liquid ejection head is detachably attached.

According to this configuration, even when the first supply flow path is coupled to the liquid flow path joint and the second supply flow path is coupled to the gas flow path joint, it is possible to improve the workability.

What is claimed is:

1. A liquid ejection device comprising:
a head unit including a liquid ejection head that ejects liquid in an ejection direction and
a plurality of wiring sections that are attachable to and detachable from the head unit and that supply electric signals to the liquid ejection head, wherein
the head unit includes a flow path joint configured to couple to a downstream end of a supply flow path for supplying liquid to the liquid ejection head,
the liquid ejection head is a line head extending in a longitudinal direction that intersects the ejection direction, and
when viewed from the ejection direction while the plurality of wiring sections is mounted to the head unit, the wiring sections do not overlap with the supply flow path coupled to the flow path joint at a position where the wiring sections overlap with the liquid ejection head.

2. The liquid ejection device according to claim 1, further comprising:
a relay board that is attachable to and detachable from the head unit and that is configured such that the plurality of wiring sections is detachably attached thereto, wherein
when viewed from the ejection direction and when the relay board is mounted on the head unit, the relay board does not overlap the supply flow path coupled to the flow path joint at a position overlapping the liquid ejection head.

3. The liquid ejection device according to claim 2, wherein
the head unit includes a supply section for supplying liquid to the liquid ejection head,
the supply section includes the flow path joint, and
when viewed from the ejection direction, the relay board does not overlap the supply section at a position overlapping the liquid ejection head.

4. The liquid ejection device according to claim 3, wherein
when viewed from the ejection direction, the relay board and the supply section are arranged at positions straddling an imaginary line extending in the longitudinal direction.

5. The liquid ejection device according to claim 1, wherein
the flow path joint is a liquid flow path joint to which a downstream end of a first supply flow path for supplying liquid to the liquid ejection head is detachably attached and
the head unit includes a gas flow path joint to which a downstream end of a second supply flow path for supplying a gas to deliver liquid to the liquid ejection head is detachably attached.
